(19) United States
(12) Patent Application Publication
(10) Pub. No.: US 2021/0027324 A1
(43) Pub. Date: Jan. 28, 2021

(54) IMPROVING ACCURACY OF EXPERIMENTAL RESULTS THROUGH GEO SELECTION

(71) Applicant: Google LLC, Mountain View, CA (US)

(72) Inventors: Nicolas H. Remy, Marly le Roi (FR); Timothy Chun-Wai Au, Milpitas, CA (US)

(21) Appl. No.: 16/499,906

(22) PCT Filed: Jul. 11, 2018
(86) PCT No.: PCT/US2018/041671

§ 371 Date: Oct. 1, 2019

(51) Int. Cl. G06Q 30/02

(52) U.S. Cl. CPC G06Q 30/0205; G06Q 30/0244; G06Q 30/0201

(57) ABSTRACT

Methods, systems, and apparatus, including computer programs encoded on a computer storage medium, for creating an initial treatment group that includes geographic regions; creating a matching control group for the initial treatment group; creating an updated treatment group that includes the geographic regions from the initial treatment group and an additional geographic region that provides a specified level of increase to a model quality metric; iteratively creating each of i) an updated matching control group based on the updated treatment group and ii) an additional updated treatment group based on the updated matching control group until a stop condition occurs; receiving input specifying a treatment group size; and in response to receiving the input, conducting the experiment using i) the updated treatment group that includes a number of geographic regions that matches the treatment group size and ii) the updated matching control group created for that updated treatment group.

### FIELD

The present specification relates to data processing, and improving the accuracy of experimental results through selection of geographies utilized in the experiments.

### BACKGROUND

In general, to measure the effect of online digital content on offline behavior, randomized experiments can be utilized. For example, to measure the effects of presenting a particular set of online digital content on user behavior (e.g., visits to particular locations) in a specific region, randomized experimentation could be implemented by randomly segmenting a user population into two groups, e.g., a control group and a treatment group. The treatment group would receive online digital content from the particular set of online digital content while the control group would not receive such. A comparison of the offline behavior of the control group and the treatment group can reveal how exposure to the particular set of online digital content affected the offline behavior of users.

### SUMMARY

Innovative aspects of the subject matter described in this specification may be embodied in methods that include the actions of creating, for one or more experiments, an initial treatment group that includes one or more geographic regions; creating a matching control group for the initial treatment group that includes one or more geographic regions that are not included in the initial treatment group; creating an updated treatment group that includes the geographic regions from the initial treatment group and an additional geographic region, from among multiple different eligible geographic regions, that provides a specified level of increase to a model quality metric relative to a level of the model quality metric provided by the initial treatment group; iteratively creating each of i) an updated matching control group based on the updated treatment group and ii) an additional updated treatment group based on the updated matching control group until a stop condition occurs, wherein each additional updated treatment group includes an additional geographic region than a preceding treatment group; receiving input specifying a treatment group size for a given experiment; and in response to receiving the input specifying the treatment group size for the given experiment, conducting the experiment using i) the updated treatment group that includes a number of geographic regions that matches the treatment group size and ii) the updated matching control group created for that updated treatment group.

Other embodiments of these aspects include corresponding systems, apparatus, and computer programs, configured to perform the actions of the methods, encoded on computer storage devices.

These and other embodiments may each optionally include one or more of the following features. For instance, creating a matching control group for the initial treatment group comprises: determining a first level of the model quality metric based on results provided by an experiment model using the initial treatment group and an initial control group for the initial treatment group; for each additional geographic regions among multiple different candidate control geographic regions: i) creating a neighboring control group that includes an additional geographic region or excludes one of the geographic regions included in the initial control group for the initial treatment group, and ii) determining a second level of the model quality metric based on results provided by the experimental model using the initial treatment group and the neighboring control group; assigning, as the matching control group for the initial treatment group, one of the neighboring control groups that corresponds to a highest second level of the model quality metric. Obtaining geographic requirement data specifying a set of geographic regions that are required to be included in the initial treatment group; and obtaining control data specifying a set of geographic regions that are allowed to be included in a control group of the experiment, wherein: creating the initial treatment group that includes the one or more geographic regions comprises creating the initial treatment group to include the set of geographic regions that are required to be included in the initial treatment group; and creating the matching control group for the initial treatment group that includes the one or more geographic regions that are not included in the initial treatment group comprises including, in the matching control group, at least one geographic region from the set of geographic regions that are allowed to be included in the control group of the experiment. Creating the updated treatment group comprises: for each additional geographic region among one or more additional geographic regions that are eligible for inclusion in the updated treatment group: creating a candidate treatment group that includes the additional geographic region and geographic regions that are currently included in an existing treatment group for the experiment; determining whether the candidate treatment group provides a higher level of the model quality metric than the existing treatment group; and determining whether to add the additional geographic region to the existing treatment group based on whether the candidate treatment group provides a higher level of the model quality metric than the existing treatment group, including adding the additional geographic region to the existing treatment group to create the updated treatment group when the candidate treatment group provides a higher level of the model quality metric than the existing treatment group, and not adding the additional geographic region to the existing treatment group when the candidate treatment group fails to provide a higher level of the model quality metric than the existing treatment group. Iteratively creating each of the updated matching control group and the updated treatment group until a maximum specified number of geographic regions are included in the updated treatment group. Iteratively creating each of the updated matching control group and the updated treatment group until an addition of another geographic region to an existing treatment group fails to improve the level of the model quality metric relative to the level of the model quality metric provided by the existing treatment group. Modifying how content is distributed in the geographic regions included in the updated treatment group and not modifying how content is distributed in the geographic regions included in the matching control group.

Particular implementations of the subject matter described in this specification can be implemented so as to realize one or more of the following advantages. For example, the subject matter disclosed below improves the accuracy that is achievable through geographically defined experiments over traditional geographically defined experiments. The accuracy is increased, for example, through an exploration process that identifies specific geographic regions for each of the treatment group and the control group that will provide the most precise (or at least a specified level of precision) in experiment results. As discussed below, this exploration process, which can be referred to as a matched markets approach, includes creating a treatment group of geographic regions, and then finding a matching control group of geographic regions that will provide the lowest (or a specified level) of uncertainty. The exploration process can efficiently search the set of all possible control and treatment groups, and also eliminates the issues that arise when trying to specify treatment and control geographies using a set of criteria such as sales in stores or demographic information, which do not include any information about the precision that will be achieved through the experiment.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 depicts a system for selection of geographic regions for experimentation.

FIGS. 2A-2C depict illustrations of different groups of the geographic regions.

FIG. 3 depicts an algorithm for the selection of geographic regions for experimentation.

FIG. 4 is a flowchart of an example process for selection of geographic regions for experimentation.

FIG. 5 depicts an example computing system that may be used to implement the techniques described herein.

### DETAILED DESCRIPTION

Historically, geographic experiments have been performed by randomly segmenting a user population into two groups (e.g., control and treatment groups). However, it may be not be possible to rely on randomization when designing a geographic experiment. For example, randomization may be not create balanced experimental groups when some of the geographic regions are markedly different from other geographic regions, or when there are only a few geographic regions available for experiment. Further, randomization may be not be feasible given certain experiment requirements—such as a need to run smaller scale geographic experiments within a given budget, or include specific geographic regions in specific experimental groups. Furthermore, the ability of users to move between geographic regions can reduce the accuracy of geographic experiments. Thus, implementation of such randomized experiments can be difficult to implement.

This document describes methods, systems, and computer readable medium for improving the accuracy of experimental results through selection of geographies utilized in the experiments. The described selection process overcomes the shortfalls of randomized geographic experiments, for example, by identifying a control group of geographic regions that provide the best precision (or at least a specified amount of precision) in view of the treatment geographic regions that have been selected. Specifically, points of interest (such as physical stores) can be located within the geographic regions. In some cases, the geographic region can be the smallest physical area that includes the majority of visitors to the point of interest. These geographic regions can be used for exposure of digital content (e.g., advertisements or other information). For example, a first geographic region can be used as a control geographic region (e.g., no exposure to the digital content within the geographic region) while a second geographic region can be used as a treatment geographic region (e.g., exposure to the digital content). The particular geographic regions that are included in each of the treatment geographic region and the control geographic region can be selected, for example, so that the results of experiments performed using the treatment and control geographic regions provide the most precision (or at least a specified amount of precision), which can be referred to as the most suitable geographic regions. The process that selects the most suitable geographic regions for experimentation by optimizing a desired metric of interest, including evaluating each possible combination of geographic regions.

In some cases, the selection process begins with an initial treatment group that includes a set of geographic regions is created; and a matching control group for the initial treatment group is created that includes geographic regions not included in the initial treatment group. In other words, the initial treatment group can include a first set of geographic regions (for application of the treatment—e.g., exposure of the digital content) and the initial control group that matches the specific initial treatment group can include a second set of geographic regions not included by the first set (for control—e.g., no exposure of the digital content). An updated treatment group can then be created that includes the geographic regions from the initial treatment group and an additional geographic region. In other words, the updated treatment group is increased by one geographic region (or possibly more than one geographic region) over the initial treatment group. Furthermore, the additional geographic region is selected that provides a specified level of increase to a model quality metric as compared to a level of the model quality metric provided by the initial treatment group. That is, the addition of the geographic region to the initial treatment group to form the updated treatment group increase the level of the model quality metric as compared to the initial treatment group. An updated matching control group can then be created based on the updated treatment group, and the process of creating treatment groups and matching control groups can be repeated iteratively until a stop condition occurs. Experimentation can then be conducted, including, receiving input specifying a treatment group size for a given experiment and conducting the experiment using i) the treatment group that includes a number of geographic regions that matches a received treatment group size and ii) a matching control group created for the treatment group.

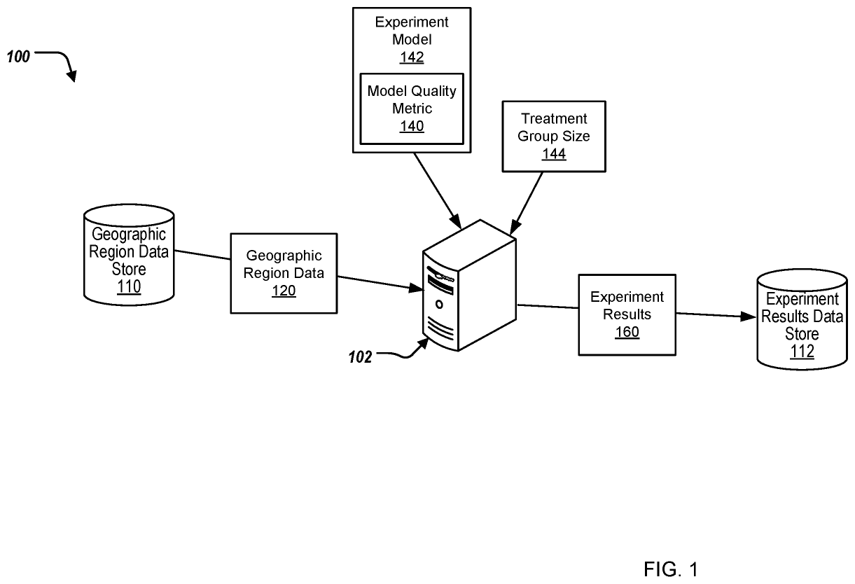

FIG. 1 depicts a system 100 for selection of geographic regions for experimentation. The system 100 includes a computing device 102, a geographic region data store 110, and an experiment results data store 112. The computing device 102 can be in communication with the databases 110, 112 over one or more networks (not shown). In some examples, the computing device 102 can include one or more modules, and can be implemented as a combination of computing systems or in a same set of physical hardware.

In some examples, the computing device 102 can obtain geographic region data 120 from the geographic region data store 110. The geographic region data 120 can include data that defines geographic regions, including such data as a location of a point of interest included by the geographic region, geographic dimensions of the geographic region, and a geographic location of the geographic region. The computing device 102 can further receive data identifying an experiment model 142 that includes data indicating a model quality metric 140. The experiment model 142 can be applied selectively, by the computing device 102, to geographic regions of the geographic region data 120 to identify results from distribution of digital content within the selected geographic regions, described further herein. Furthermore, the model quality metric 140 can be related to distribution of the digital content within the selected regions, described further herein.

In short, the computing device 102 can create treatment groups and control groups that each include geographic regions from the geographic region data 120. The computing device 102 can conduct experiments using the treatment groups and/or the control groups—that is, modifying how digital content is distributed in the geographic regions contained by the treatment group and not modifying how digital content is distributed in the geographic regions contained by the control group, described further herein. In some examples, the geographic region data 120 obtained by the computing device 102 can include i) data specifying which geographic regions that are required to be included in the treatment groups and ii) data specifying which geographic regions that are allowed to be included in the control groups.

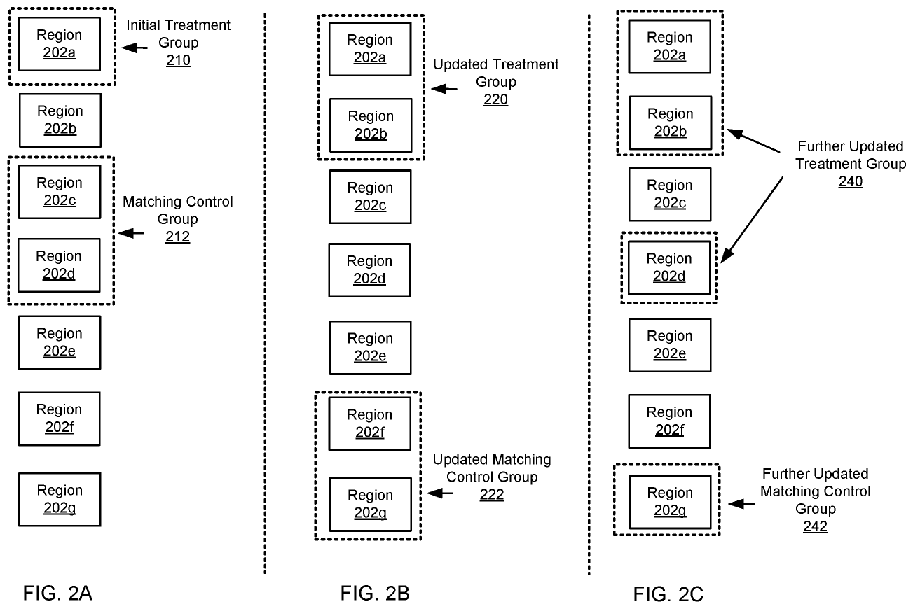

In some implementations, the computing device 102 creates, for one or more experiments, an initial treatment group that includes one or more geographic regions. FIG. 2A illustrates a plurality of geographic regions 202a, 202b, 202c, 202d, 202e, 202f, 202g, collectively referred to as geographic regions 202. The geographic region data 120 can include data indicating the geographic regions 202. In the illustrated example, the computing device 102 creates the initial treatment group 210 that includes the geographic region 202a. In some examples, the initial treatment group 210 can provide a value (or level) of the model quality metric 140. The model quality metric 140 can be a metric of an objective function that is to be optimized by the computing system 102, e.g., optimized based on parameters desired by the system 100 and/or provided by a user of the system 100. For example, the geographic regions 202 can include regions that receive distribution of digital content on respective computing devices, e.g., advertisement digital content that is provided to computing devices that include user profile data that indicates inclusion within the respective geographic regions. In this example, the model quality metric 140 can include metrics related to distribution of the digital content and effects of such distribution exhibited by the users—e.g., engagement by the users with points of interest(s) included by the geographic regions 202 that received the distribution of digital content. For example, a metric can include an in-store sales volume of the point of interest; however, any metric can be used for any model that is desired to be optimized related to the distribution of digital content within the geographic regions 202.

In the illustrated example, the computing device 102 creates the initial treatment group 210 that includes a single geographic region, e.g., the geographic region 202a. The computing device 102 can create the initial treatment group 210 such that the initial treatment group 210 provides a specified level of the model quality metric 140. That is, the computing device 102 selects the geographic region 202a for inclusion within the initial treatment group 210 such that the initial treatment group 210 provides a specified level of the model quality metric 140. In some examples, the computing device 102 selects the geographic region 202a for inclusion within the initial treatment group 210 that provides an optimized level of the model quality metric 140.

In some examples, the computing device 102 creates the initial treatment group to include a set of the geographic regions that are indicated as required to be included in the initial treatment group as indicated by the geographic region data 120. For example, the computing device 102 creates the initial treatment group 210 to include the geographic region 202a as the geographic region 202a is required to be included in the initial treatment group 210 as indicated by the geographic region data 120. In some examples, the geographic region data 120 can indicate a number of geographic regions, e.g., two or more of the geographic regions 202, to be included within any treatment group, including the initial treatment group 210.

In some implementations, the computing device 102 creates a matching control group for the initial treatment group that includes geographic regions that are not included by the initial treatment group. That is, the computing device 102, in the illustrated example of FIG. 2A, creates the matching control group 212 for the initial treatment group 210. The matching control group 212 includes the geographic regions 202c and 202d that are not included by the initial treatment group 210. In some examples, the computing device 102 selects the geographic regions 202c and 202d from the available geographic regions 202b, 202c, 202d, 202e, 202f, 202g to optimize the model quality metric 140 that can be determined using the initial treatment group 210 and the matching control group 212. Specifically, the computing device 102 can conduct an experiment using the experiment model 142 using the initial treatment group 210 and an initial control group for the initial treatment group.

For example, the computing device 102 can conduct an experiment with the experiment model 142 using the initial treatment group 210 and an initial control group for the initial treatment group. The computing device 102, for each additional geographic region among multiple different candidate geographic regions 202, i) creates a neighboring control group that includes an additional geographic region or excludes one of the geographic regions included in the initial control group for the initial treatment group 210, and ii) determines a level of the model quality metric 140 based on results provided by the experiment model 142 using the initial treatment group 210 and the neighboring control group. For example, the computing device 102, for each additional geographic region 202, creates a neighboring control group for each combination of available geographic regions 202—e.g., geographic regions 202 that are not included by the initial treatment group 210 (geographic regions 202b, 202c, 202d, 202e, 202f, 202g). The computing device 102, for each combination of available geographic regions 202—that is, for each neighboring control group, determines a level of the model quality metric 140 based on the results provided by the experiment model 142 using the initial treatment group 210 and the neighboring control group. For example, the computing device 210 applies the experiment model 140 to each combination of the i) initial treatment group 210 and ii) the neighboring control group—e.g., any combination of the geographic regions 202b, 202c, 202d, 202e, 202f, 202g. The computing device 120 can then determine the level of the model quality metric 142 provided by the experiment model 142 for each combination of the i) initial treatment group 210 and ii) the neighboring control group. The computing device 102 can assign one of the neighboring control groups that corresponds to a highest level of the model quality metric 140 as the matching control group 212 for the initial treatment group 210. For example, the computing device 102 can assign the neighboring control group that includes the geographic regions 202c, 202d to the matching control group 212 as the neighboring control group that includes the geographic region 202c, 202d corresponds to the highest second level of the model quality metric 140.

In some examples, the computing device 102 creates the matching control group to include geographic regions 202 that are allowed to be included in the matching control group 212, as indicated by the geographic region data 120. For example, the computing device 102 creates the matching control group 212 to include a subset of the geographic regions 202b, 202c, 202d, 202e, 202f, 202g in the matching control group 212 as any of the geographic regions 202b, 202c, 202d, 202e, 202f, 202g are allowed to be included in the matching control group 212, e.g., as indicated by the geographic region data 120.

In some implementations, the computing device 102 creates an updated treatment group that includes the geographic regions from the initial treatment group and an additional geographic region from among multiple different eligible geographic regions. That is, the computing device 102, in the illustrated example of FIG. 2B, creates the updated treatment group 220 that includes the geographic regions 202a and 202b. In some examples, the computing device 102 selects the additional geographic region from the multiple different eligible geographic regions such that the additional geographic region and the geographic region from the initial treatment group provide a specified level of increase to the model quality metric of the updated treatment group relative to the level of the model quality metric provided by the initial treatment group. In the illustrated example of FIG. 2B, the computing device 102 selects the geographic region 202b from the geographic regions 202b, 202c, 202d, 202e, 202f, 202g such that the geographic region 202b and the geographic region 202a from the initial treatment group 210 provide a specified level of increase to the model quality metric 140 of the updated treatment group 220 relative to the value of the model quality metric 140 provided by the initial treatment group 210. Specifically, the computing device 102 can conduct an experiment using the experiment model 142 using the updated treatment group 210. For example, the computing device 102 can conduct an experiment with the experiment model 142 using the updated treatment group 220—that is, the initial treatment group 210 and the additional geographic region. The computing device 102, for each additional geographic region from multiple different geographic regions of the geographic region data 120 that are eligible for inclusion in the updated treatment group 220, determines a level of increase to the model quality metric 140 based on results provided by the experiment model 142 using the initial treatment group 210 and the additional geographic region. For example, the computing device 102, for each additional geographic region 202, determines a level of increase to the model quality metric 140 based on the results provided by the experiment model 142 using the initial treatment group 210 and the additional geographic region 202. In other words, the computing device 210 applies the experiment model 142 to each combination of the i) initial treatment group 210 and ii) the additional geographic region 202 to determine a level of increase of the model quality metric 140 provided by the experiment model 142 for each combination of the i) initial treatment group 210 and ii) the additional geographic region 202. The computing device 102 can then select one of the additional geographic regions 202 that corresponds to a highest level of increase of the model quality metric 140. The computing device 102 can create the updated treatment group 220 that includes the geographic region 202a from the initial treatment group 210 and the additional geographic region 202b that corresponds to the highest level of increase of the model quality metric 140.

In some examples, the computing device 102 creates a candidate treatment group that includes an additional geographic region and the geographic region that is currently included in any existing treatment group for the experiment. The computing device 102, for each additional geographic region of the multiple different geographic regions of the geographic region data 120 that are eligible for inclusion in the updated treatment group, creates a candidate treatment group that includes the geographic region of the existing treatment group and the additional geographic region. The computing device 102 determines, for each additional geographic region of the multiple different geographic regions of the geographic region data 120 that are eligible for inclusion in the updated treatment group, whether the candidate treatment group provides a higher level of the model quality metric 140 than the existing treatment group, e.g., based on the results provided by the experiment model 142 using the candidate treatment group. The computing device 102 does not add the additional geographic region to the existing treatment group when the candidate treatment group fails to provide a higher level of the model quality metric 140 than the existing treatment group.

In some implementations, the computing device 102 iteratively creates each of i) an updated matching control group based on the updated treatment group and ii) an additional updated treatment group based on the updated matching control group until a stop condition occurs. In the illustrated example of FIG. 2B, the computing device 102 creates the updated matching control group 222 based on the updated treatment group 220. The updated matching control group 222 includes the geographic regions 202f and 202g that are not included by the updated treatment group 220. In some examples, the computing device 102 selects the geographic regions 202f and 202g from the available geographic regions 202c, 202d, 202e, 202f, 202g to optimize the model quality metric 140 that can be determined using the updated treatment group 220 and the selected geographic regions 202 of the updated matching control group 222.

For example, the computing device 102 can conduct an experiment with the experiment model 142 using the updated treatment group 220 and an updated control group for the updated treatment group 220. The computing device 102, for each additional geographic region among multiple different candidate control geographic regions of the geographic region data 120, i) creates a neighboring control group that includes an additional geographic region or excludes one of the geographic regions included in the updated control group for the updated treatment group, and ii) determines a level of the model quality metric 140 based on results provided by the experiment model 142 using the updated treatment group and the neighboring updated control group. For example, the computing device 102, for each additional geographic region 202, creates a neighboring updated control group for each combination of available geographic regions 202—e.g., geographic regions 202 that are not included by the updated treatment group 210 (geographic regions 202c, 202d, 202e, 202f, 202g). The computing device 102, for each combination of available geographic regions 202—that is, for each neighboring updated control group, determines a level of the model quality metric 140 based on the results provided by the experiment model 142 using the updated treatment group 220 and the neighboring updated control group. For example, the computing device 210 applies the experiment model 142 to each combination of the i) updated treatment group 220 and ii) the neighboring updated control group—e.g., any combination of the geographic regions 202c, 202d, 202e, 202f, 202g and determines the level of the model quality metric 202 provided by the experiment model 142 for each combination of the i) updated treatment group 220 and ii) the neighboring updated control group. The computing device 102 can then assign one of the neighboring updated control groups that corresponds to a highest level of the model quality metric 140 as the matching updated control group for the updated treatment group. For example, the computing device 102 can assign the neighboring updated control group that includes the geographic regions 202f, 202g to the updated matching control group 222 as the neighboring updated control group that includes the geographic region 202f, 202g corresponds to the highest level of the model quality metric 140.

Furthermore, the computing device 102 creates the further updated treatment group that includes the geographic regions from the updated treatment group and an additional geographic region from among multiple different eligible geographic regions. That is, the computing device 102, in the illustrated example of FIG. 2C, creates the further updated treatment group 240 that includes the geographic regions 202a, 202b, 202d. In some examples, the computing device 102 selects the additional geographic region from the multiple different eligible geographic regions such that the additional geographic region and the geographic regions from the updated treatment group provide a specified level of increase to the model quality metric of the further updated treatment group relative to the level of the model quality metric provided by the updated treatment group. Specifically, the computing device 102, for each additional geographic region of the multiple different geographic regions of the geographic region data 120 that are eligible for inclusion in the further updated treatment group 240, determines a level of increase to the model quality metric 140 based on results provided by the experiment model 142 using the updated treatment group 220 and the additional geographic region. For example, the computing device 102, for each additional geographic region 202, determines a level of increase to the model quality metric 140 based on the results provided by the experiment model 142 using the updated treatment group 220 and the additional geographic region 202. For example, the computing device 102 applies the experiment model 142 to each combination of the i) updated treatment group 220 and ii) the additional geographic region 202. The computing device 102 determines a level of increase of the model quality metric 202 provided by the experiment model 142 for each combination of the i) updated treatment group 220 and ii) the additional geographic region 202. The computing device 102 can then select one of the additional geographic regions 202 that corresponds to a highest level of increase of the model quality metric 140. The computing device 102 can create the further updated treatment group 240 that includes the geographic regions 202a, 202b from the updated treatment group 220 and the additional geographic region 202d that corresponds to the highest level of increase of the model quality metric 140.

Furthermore, in the illustrated example of FIG. 2C, the computing device 102, creates the further updated matching control group 242 based on the further updated treatment group 240. The further updated matching control group 242 includes the geographic region 202g. In some examples, the computing device 102 selects the geographic region 202g from the available geographic regions 202c, 202e, 202f, 202g to optimize the model quality metric 140 that can be determined using the further updated treatment group 240 and the selected geographic regions 202 of the further updated matching control group 242. For example, the computing device 102 can conduct an experiment using the experiment model 142 using i) the further updated treatment group 240 and ii) a neighboring further updated control group that is a combination of the geographic regions 202c, 202e, 202f, 202g. The computing device 210 determines the level of the model quality metric 140 provided by the experiment model 142 for each combination of the i) further updated treatment group 240 and ii) a neighboring further updated control group. The computing device 102 can then assign one of the neighboring further updated control groups that corresponds to a highest level of the model quality metric 140 as the further updated matching control group for the further updated treatment group. For example, the computing device 102 can assign the neighboring further updated control group that includes the geographic region 202g to the further updated matching control group 242 as the neighboring further updated control group that includes the geographic region 202g corresponds to the highest level of the model quality metric 140.

In some examples, the computing system 102 iteratively creates the updated matching control groups and the updated treatment groups until a stop condition occurs. That is, the computing system 102 iteratively creates the treatment groups (e.g., the treatment groups 210, 220, 240) and the matching control groups (e.g., the control groups 212, 222, 242) until the stop condition occurs. In some examples, the stop condition can be associated with a maximum specified number of geographic regions that are to be included in an updated treatment group. Specifically, the computing system 102 can iteratively create the updated matching control groups and the updated treatment groups until the maximum specified number of geographic regions are included in the (last/final) updated treatment group. In some examples, the computing system 102 can receive data indicating the maximum specified number of geographic regions for use in the stop condition. For example, referring to FIGS. 2A, 2B, 2C, the maximum specified number of geographic regions for the stop condition is three, and thus, the computing system 102 can iteratively create the treatment groups (e.g., the treatment groups 210, 220, 240) and the matching control groups (e.g., the control groups 212, 222, 242) until three geographic regions are included in the ultimate treatment group—e.g., the further updated treatment group 240. The data indicating the maximum specified number of geographic regions for use in the stop condition can be provided by a user of the computing system 102, or determined automatically based on the number of geographic regions of the geographic region data 120.

In some examples, the computing system 102 can iteratively create the updated matching control groups and the updated treatment groups until an addition of another geographic region to an existing treatment group fails to improve the level of the model quality metric 140 relative to the level of the model quality metric 140 provided by the existing treatment group. That is, the computing device 102 determines that the addition of another geographic region to an existing treatment groups fails to increase the model quality metric 140 based on the results provided by the experiment model 142. For example, the computing device 102 can determine that the addition of another geographic region to the further updated treatment group 240 fails to increase the model quality metric 140 based on the results provided by the experiment model 142, and thus, the stop condition is met and the computing system 102 stops iteratively creating the updated matching control groups and the updated treatment groups.

In some examples, the computing device 102 creates the additional updated treatment groups such that each additional updated treatment group includes an additional geographic region than a preceding treatment group. For example, the computing device 102 creates the further updated treatment group 240 to include the geographic region 202d that is an additional geographic region than the preceding treatment group—i.e., the updated treatment group 220.

In some implementations, the computing system 102 receives input 144 specifying a treatment group size for a given experiment. That is, the treatment group size input 144 indicates a specific number of geographic regions of the geographic data 120 for the treatment group for a given experiment. For example, the input 144 can indicate two geographic regions for the treatment group for the given experiment—i.e., the updated treatment group 220. In response to receiving the input 144 specifying the treatment group size for the given experiment, the computing device 102 conducts the experiment using i) the updated treatment group that includes the number of geographic regions that matches the treatment group size of the input 144 and ii) the updated matching control group created for that updated treatment group. For example, the computing device 102 can conduct an experiment using i) the updated treatment group 220 and ii) the updated matching control group 222. In some examples, the computing device 102 can provide experiment results 160 to the experiment results data store 112. In some examples, the experiment results 160 can include data associated with providing the digital content to the i) the updated treatment group that includes the number of geographic regions that matches the treatment group size of the input 144 and ii) the updated matching control group created for that updated treatment group. In some examples, conducting the experiment by the computing device 102 can include modifying how digital content is distributed in the geographic regions included in the updated treatment group and not modifying how digital content is distributed in the geographic regions included in the matching control group. Specifically, the computing device 102 can modify how digital content is distributed in the geographic regions 202a, 202b in the updated treatment group 220 and not modify how digital content is distributed in the geographic regions 202f, 202g included in the updated matching control group 222.

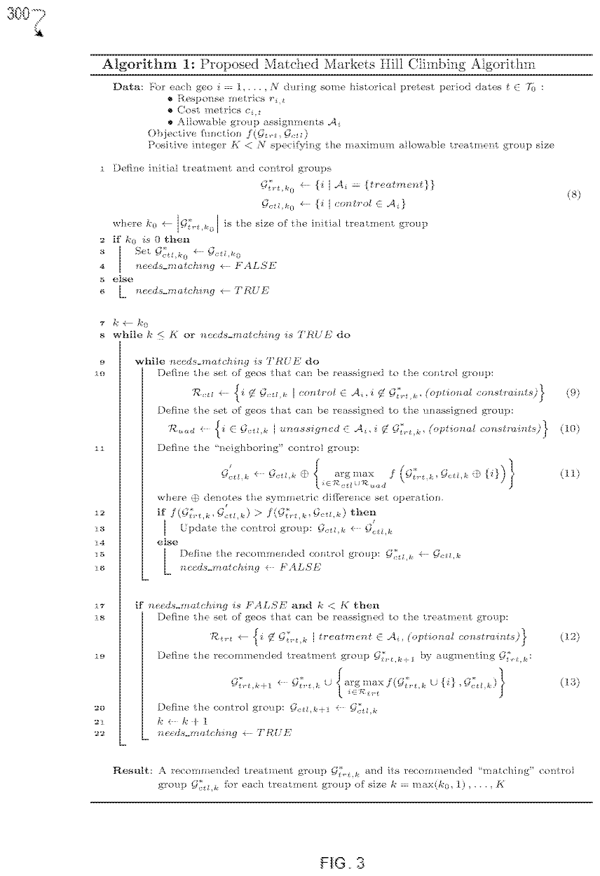

Referring to FIG. 3, in some examples, a hill climbing algorithm 300 can be utilized in the system 100 of FIG. 1. Specifically, the hill climbing algorithm 300 can be used to optimize an objective function f—i.e., the model quality metric 140. The algorithm 300 alternates between a matching phase that identifies a “best” set of geographic regions of a control group given a current set of geographic regions of a treatment group, and an augmentation phase that determines whether to add one new geographic region to the treatment group given the current control group. This procedure is repeated until the treatment group reaches a maximum allowed size, e.g., as indicated by stop condition. Additionally, the hill climbing algorithm 300 also requires a specified set of allowable experimental group assignments Ai and metric(s) of interest m_{i,t} for each geographic region i=1, . . . , N during some a pretest period dates t∈T₀. Letting k₀=|{i|Ai={treatment}}| denote the number of geographic regions required to be assigned to the treatment group, the algorithm 300 also optionally allows a positive integer K that indicates the maximum number of geographic regions in the treatment group for the experiment. Given these inputs, the algorithm 300 provides several different experimental design choices—one for each treatment group of size k=max(k₀, 1) , . . . , K. In particular, for each k, a recommended treatment group G*_{trt,k} is specified and the matching control group G*_{ctl,k,} where an asterisk is used in the superscript to differentiate these recommended groups from other non-recommended groups. Furthermore, note that k=|G*_{trt,k}| as the recommended treatment group G*_{trt,k} will contain exactly k geographic regions. The subscript k for the recommended control group G*_{ctl,k} only indicates which recommended treatment groups G*_{trt,k} it is paired with.

The algorithm 300 begins by initializing the geographic regions to the experimental groups as defined by equation (8) in line 1 of the algorithm 300. In particular, the initial recommended treatment group G*_{trt,k0} contains the geographic regions that are required to be assigned to the treatment group, while the initial control group G_{ctl,k0} consists of the geographic regions that are allowed to be assigned to the control group. Afterwards, depending on whether or not the recommended matching control group G*_{ctl,k} for G*_{trt,k} has already been determined, the algorithm 300 can then repeatedly alternate between a “matching” routine and an “augmentation” routine until the stopping rule is reached. Note that lines 2-6 of algorithm 300 determine which routine is used first—a decision based on whether or not any of the geographic regions are required to be in the treatment group.

In the matching routine outlined by lines 9-16 of the algorithm 300, the matching control group G*_{ctl,k} for a given recommended treatment group G*_{trt,k} is found by incrementally updating a non-recommended control group G_{ctl,k} until a local optimum is reached. This is accomplished by first finding the sets R_{ctl} and R_{uad} as defined by equations (9) and (10) that contain the geographic regions which are eligible to be reassigned to the control groups or unassigned groups, respectively. Afterwards, as defined by equation (11), a “neighboring” control group G′_{ctl,k} is derived from G_{ctl,k} by reallocating the geographic regions whose reassignment—either from the control group to the unassigned group or from the unassigned group to the control group—maximizes f when used in conjunction with the recommended treatment group G*_{trt,k}. Then, as described by lines 12-13 of Algorithm 1, if f(G*_{trt,k}, G′_{ctl,k})>f(G*_{trt,k}, G′_{ctl,k})—that is, if G′_{ctl,k} leads to a higher quality model than G_{ctl,k} when paired with G*_{trt,k}—then the algorithm 300 will update the definition of the control group G_{ctl,k} to coincide with G′_{ctl,k}, and this updated control group will then be used in the next iteration of the matching routine.

However, if f(G*_{trt,k}, G′_{ctl,k})≤f(G*_{trt,k}, G_{ctl,k})—that is, if a local optimum has been reached—then as lines 14-16 of the algorithm 300 indicates, the algorithm 300 will take the existing set G_{ctl,k}to be the recommended matching control group G*_{ctl, k}for its recommended treatment group G*_{trt,k} of size k. Meanwhile, the augmentation routine detailed in lines 17-22 of the algorithm 300 is used to derive a larger recommended treatment group G*_{trt,k+1} of size k+1 from an existing recommended treatment group G*_{trt, k} of size k. To accomplish this, the algorithm 300 first finds the set of geographic regions Rₜᵣₜ that are eligible to be reassigned to the treatment group as defined by equation (12). Afterwards, as can be seen from equation (13), the recommended treatment group G*_{tdk}+1 of size k+1 is then constructed by augmenting the recommended treatment group G*_{trt,k} of size k with the geographic region whose reassignment to the treatment group maximizes f when used in combination with the recommended control group G*_{ctl,k}. Finally, as lines 20-22 of the algorithm 300 show, the recommended control group G*_{ctl,k} is then taken to be the starting point for the next call to the matching routine which is used to find the matching control group for G*_{trt,k+1}. As indicated by line 8 of the algorithm 300, the algorithm 300 continues to alternate between the augmentation and matching routines until it has determined a recommended treatment group G_{trt,k} and its corresponding matching control group G*_{ctl,k} for experimental designs having a treatment group of size k=max(k₀, 1) , . . . , K. In addition, each of these recommended designs locally optimizes the objective function fin terms of the requirements, and if the assumptions of the algorithm 300 hold for the entire duration of the geographic region experiment T, then the geographic region experiments that are recommended by the matched markets approach lead to straightforward causal estimates. Furthermore, a power calculation can be done for each of the recommended experimental designs to obtain an estimate of each design's experimental cost. In particular, the cost of experimentation tends to proportionally increase as the volume of the treatment group increases. Therefore, as the volume in the treatment groups recommended by the algorithm 300 increases with k, the algorithm 300 is able to provide entities (e.g., advertisers) with several geographic experiment design options of varying experimental costs.

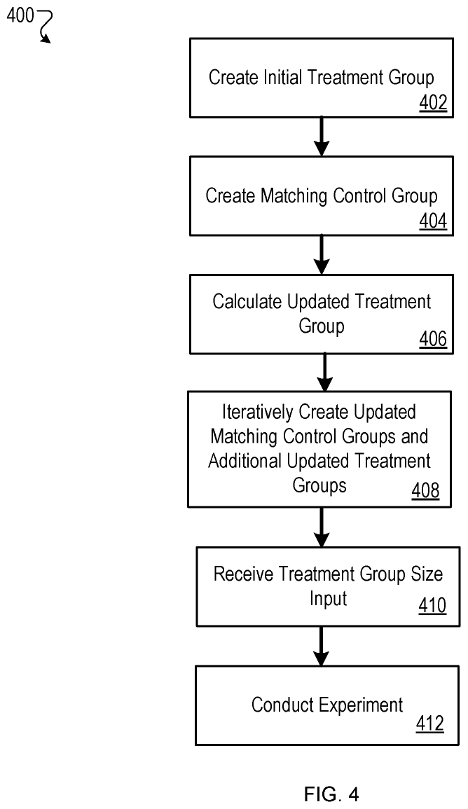

FIG. 4 illustrates an example process 400 for selection of geographic regions for experimentation. The process 400 can be performed, for example, by the computing system 102, or another data processing apparatus. The process 400 can also be implemented as instructions stored on computer storage medium, and execution of the instructions by one or more data processing apparatus cause the one or more data processing apparatus to perform some or all of the operations of the process 300.

The computing device 102 creates, for one or more experiments, an initial treatment group that includes one or more geographic regions (402). For example, the computing device 102, in the illustrated example of FIG. 2A, creates the initial treatment group 210 that includes the geographic region 202a. The computing device 102 creates a matching control group for the initial treatment group that includes geographic regions that are not included by the initial treatment group (404). For example, the computing device 102, in the illustrated example of FIG. 2A, creates the matching control group 212 for the initial treatment group 210. The matching control group 212 includes the geographic regions 202c and 202d that are not included by the initial treatment group 210. The computing device 102 creates an updated treatment group that includes the geographic regions from the initial treatment group and an additional geographic region from among multiple different eligible geographic regions (406). That is, the computing device 102, in the illustrated example of FIG. 2B, creates the updated treatment group 220 that includes the geographic regions 202a and 202b. In some examples, the computing device 102 selects the additional geographic region from the multiple different eligible geographic regions such that the additional geographic region and the geographic region from the initial treatment group provide a specified level of increase to the model quality metric of the updated treatment group relative to the level of the model quality metric provided by the initial treatment group. In the illustrated example of FIG. 2B, the computing device 102 selects the geographic region 202b from the geographic regions 202b, 202c, 202d, 202e, 202f, 202g such that the geographic region 202b and the geographic region 202a from the initial treatment group 210 provide a specified level of increase to the model quality metric 140 of the updated treatment group 220 relative to the value of the model quality metric 140 provided by the initial treatment group 210.

The computing device 102 iteratively creates each of i) an updated matching control group based on the updated treatment group and ii) an additional updated treatment group based on the updated matching control group until a stop condition occurs (408). For example, the computing device 102, in the illustrated example of FIG. 2C, creates the updated matching control group 222 based on the updated treatment group 220. The updated matching control group 222 includes the geographic regions 202f and 202g that are not included by the updated treatment group 220. Additionally, the computing device 102, in the illustrated example of FIG. 2C, creates the further updated treatment group 240 that includes the geographic regions 202a, 202b, 202d. Furthermore, in some examples, the stop condition can be associated with a maximum specified number of geographic regions that are to be included in an updated treatment group. The computing system 102 receives input 144 specifying a treatment group size for a given experiment (410). That is, the treatment group size input 144 indicates a specific number of geographic regions of the geographic data 120 for the treatment group for a given experiment. In response to receiving the input 144 specifying the treatment group size for the given experiment, the computing device 102 conducts the experiment using i) the updated treatment group that includes the number of geographic regions that matches the treatment group size of the input 144 and ii) the updated matching control group created for that updated treatment group (412). For example, the computing device 102 can conduct an experiment using i) the updated treatment group 220 and the updated matching control group 222.

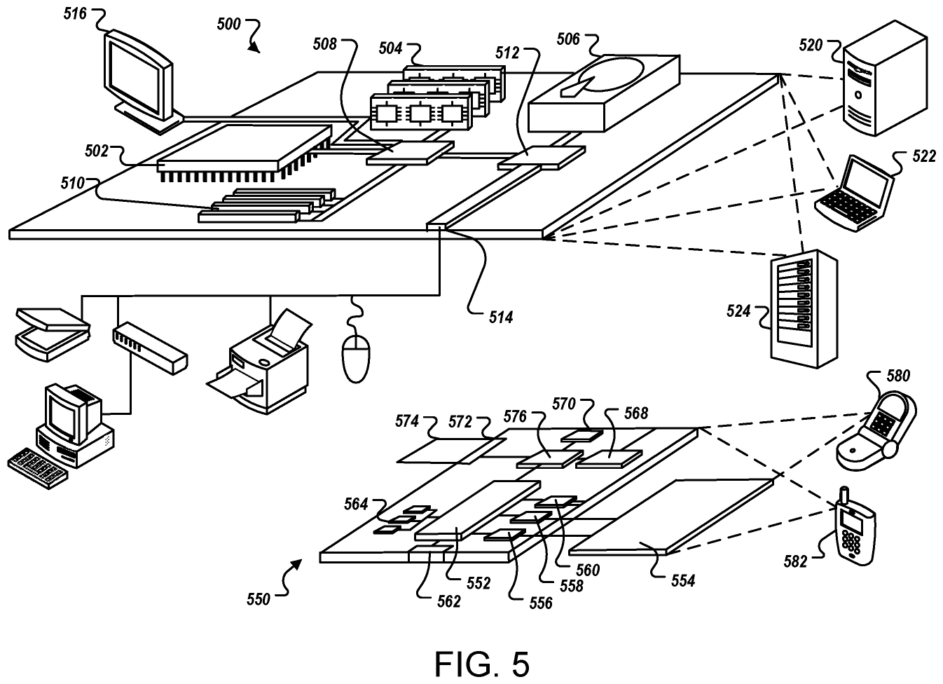

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 may process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier is a computer- or machine-readable medium, such as the memory 504, the storage device 506, or a memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 570, and a transceiver 568, among other components. The device 550 may also be provided with a storage device, such as a microdrive or other device, to provide additional storage. Each of the components 550, 552, 564, 554, 570, and 568, are interconnected using various buses, and several of the components may be mounted on a common motherboard or in other manners as appropriate.

The processor 552 may execute instructions within the computing device 500, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be in communication with processor 552 so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 may be implemented as one or more of a computer-readable medium or media, a volatile memory unit or units, or a non-volatile memory unit or units. Expansion memory 554 may also be provided and connected to device 550 through expansion interface 552, which may include, for example, a SIMM (Single In Line Memory Module) card interface. Such expansion memory 554 may provide extra storage space for device 550, or may also store applications or other information for device 550. Specifically, expansion memory 554 may include instructions to carry out or supplement the processes described above, and may include secure information also. Thus, for example, expansion memory 554 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 554, memory on processor 552, or a propagated signal that may be received, for example, over transceiver 568 or external interface 562.

Device 550 may communicate wirelessly through communication interface 570, which may include digital signal processing circuitry where necessary. Communication interface 570 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 550 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here may be realized in digital circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

While this disclosure includes some specifics, these should not be construed as limitations on the scope of the disclosure or of what may be claimed, but rather as descriptions of features of example implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results. A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

1. A computer-implemented method, comprising:
creating, for one or more experiments, an initial treatment group that includes one or more geographic regions;
creating a matching control group for the initial treatment group that includes one or more geographic regions that are not included in the initial treatment group;
creating an updated treatment group that includes the geographic regions from the initial treatment group and an additional geographic region, from among multiple different eligible geographic regions, that provides a specified level of increase to a model quality metric relative to a level of the model quality metric provided by the initial treatment group;
iteratively creating each of i) an updated matching control group based on the updated treatment group and ii) an additional updated treatment group based on the updated matching control group until a stop condition occurs, wherein each additional updated treatment group includes an additional geographic region than a preceding treatment group;
receiving input specifying a treatment group size for a given experiment; and
in response to receiving the input specifying the treatment group size for the given experiment, conducting the experiment using i) the updated treatment group that includes a number of geographic regions that matches the treatment group size and ii) the updated matching control group created for that updated treatment group.

2. The method of claim 1, wherein creating a matching control group for the initial treatment group comprises:
determining a first level of the model quality metric based on results provided by an experiment model using the initial treatment group and an initial control group for the initial treatment group;
for each additional geographic regions among multiple different candidate control geographic regions:
i) creating a neighboring control group that includes an additional geographic region or excludes one of the geographic regions included in the initial control group for the initial treatment group, and
ii) determining a second level of the model quality metric based on results provided by the experimental model using the initial treatment group and the neighboring control group;
assigning, as the matching control group for the initial treatment group, one of the neighboring control groups that corresponds to a highest second level of the model quality metric.

3. The method of claim 1, further comprising:
obtaining geographic requirement data specifying a set of geographic regions that are required to be included in the initial treatment group; and
obtaining control data specifying a set of geographic regions that are allowed to be included in a control group of the experiment, wherein:
creating the initial treatment group that includes the one or more geographic regions comprises creating the initial treatment group to include the set of geographic regions that are required to be included in the initial treatment group; and
creating the matching control group for the initial treatment group that includes the one or more geographic regions that are not included in the initial treatment group comprises including, in the matching control group, at least one geographic region from the set of geographic regions that are allowed to be included in the control group of the experiment.

4. The method of claim 1, wherein creating the updated treatment group comprises:
for each additional geographic region among one or more additional geographic regions that are eligible for inclusion in the updated treatment group:
creating a candidate treatment group that includes the additional geographic region and geographic regions that are currently included in an existing treatment group for the experiment;
determining whether the candidate treatment group provides a higher level of the model quality metric than the existing treatment group; and
determining whether to add the additional geographic region to the existing treatment group based on whether the candidate treatment group provides a higher level of the model quality metric than the existing treatment group, including adding the additional geographic region to the existing treatment group to create the updated treatment group when the candidate treatment group provides a higher level of the model quality metric than the existing treatment group, and not adding the additional geographic region to the existing treatment group when the candidate treatment group fails to provide a higher level of the model quality metric than the existing treatment group.

5. The method of claim 1, wherein iteratively creating each of the updated matching control group based on the updated treatment group and the additional updated treatment group based on the updated matching control group until the stop condition occurs comprises iteratively creating each of the updated matching control group and the updated treatment group until a maximum specified number of geographic regions are included in the updated treatment group.

6. The method of claim 1, wherein iteratively creating each of the updated matching control group based on the updated treatment group and the additional updated treatment group based on the updated matching control group until the stop condition occurs comprises iteratively creating each of the updated matching control group and the updated treatment group until an addition of another geographic region to an existing treatment group fails to improve the level of the model quality metric relative to the level of the model quality metric provided by the existing treatment group.

7. The method of claim 1, wherein conducting the experiment comprises modifying how content is distributed in the geographic regions included in the updated treatment group and not modifying how content is distributed in the geographic regions included in the matching control group.

8. A system comprising:
one or more computers and one or more storage devices storing instructions that are operable, when executed by the one or more computers, to cause the one or more computers to perform operations comprising:
creating, for one or more experiments, an initial treatment group that includes one or more geographic regions;
creating a matching control group for the initial treatment group that includes one or more geographic regions that are not included in the initial treatment group;
creating an updated treatment group that includes the geographic regions from the initial treatment group and an additional geographic region, from among multiple different eligible geographic regions, that provides a specified level of increase to a model quality metric relative to a level of the model quality metric provided by the initial treatment group;
iteratively creating each of i) an updated matching control group based on the updated treatment group and ii) an additional updated treatment group based on the updated matching control group until a stop condition occurs, wherein each additional updated treatment group includes an additional geographic region than a preceding treatment group;
receiving input specifying a treatment group size for a given experiment; and
in response to receiving the input specifying the treatment group size for the given experiment, conducting the experiment using i) the updated treatment group that includes a number of geographic regions that matches the treatment group size and ii) the updated matching control group created for that updated treatment group.

9. The system of claim 8, wherein creating a matching control group for the initial treatment group comprises:
determining a first level of the model quality metric based on results provided by an experiment model using the initial treatment group and an initial control group for the initial treatment group;
for each additional geographic regions among multiple different candidate control geographic regions:
i) creating a neighboring control group that includes an additional geographic region or excludes one of the geographic regions included in the initial control group for the initial treatment group, and
ii) determining a second level of the model quality metric based on results provided by the experimental model using the initial treatment group and the neighboring control group;
assigning, as the matching control group for the initial treatment group, one of the neighboring control groups that corresponds to a highest second level of the model quality metric.

10. The system of claim 8, the operations further comprising:
obtaining geographic requirement data specifying a set of geographic regions that are required to be included in the initial treatment group; and
obtaining control data specifying a set of geographic regions that are allowed to be included in a control group of the experiment, wherein:
creating the initial treatment group that includes the one or more geographic regions comprises creating the initial treatment group to include the set of geographic regions that are required to be included in the initial treatment group; and
creating the matching control group for the initial treatment group that includes the one or more geographic regions that are not included in the initial treatment group comprises including, in the matching control group, at least one geographic region from the set of geographic regions that are allowed to be included in the control group of the experiment.

11. The system of claim 8, wherein creating the updated treatment group comprises:
for each additional geographic region among one or more additional geographic regions that are eligible for inclusion in the updated treatment group:
creating a candidate treatment group that includes the additional geographic region and geographic regions that are currently included in an existing treatment group for the experiment;
determining whether the candidate treatment group provides a higher level of the model quality metric than the existing treatment group; and
determining whether to add the additional geographic region to the existing treatment group based on whether the candidate treatment group provides a higher level of the model quality metric than the existing treatment group, including adding the additional geographic region to the existing treatment group to create the updated treatment group when the candidate treatment group provides a higher level of the model quality metric than the existing treatment group, and not adding the additional geographic region to the existing treatment group when the candidate treatment group fails to provide a higher level of the model quality metric than the existing treatment group.

12. The system of claim 8, wherein iteratively creating each of the updated matching control group based on the updated treatment group and the additional updated treatment group based on the updated matching control group until the stop condition occurs comprises iteratively creating each of the updated matching control group and the updated treatment group until a maximum specified number of geographic regions are included in the updated treatment group.

13. The system of claim 8, wherein iteratively creating each of the updated matching control group based on the updated treatment group and the additional updated treatment group based on the updated matching control group until the stop condition occurs comprises iteratively creating each of the updated matching control group and the updated treatment group until an addition of another geographic region to an existing treatment group fails to improve the level of the model quality metric relative to the level of the model quality metric provided by the existing treatment group.

14. The system of claim 8, wherein conducting the experiment comprises modifying how content is distributed in the geographic regions included in the updated treatment group and not modifying how content is distributed in the geographic regions included in the matching control group.

15. A non-transitory computer-readable medium storing software comprising instructions executable by one or more computers which, upon such execution, cause the one or more computers to perform operations comprising:
creating, for one or more experiments, an initial treatment group that includes one or more geographic regions;
creating a matching control group for the initial treatment group that includes one or more geographic regions that are not included in the initial treatment group;
creating an updated treatment group that includes the geographic regions from the initial treatment group and an additional geographic region, from among multiple different eligible geographic regions, that provides a specified level of increase to a model quality metric relative to a level of the model quality metric provided by the initial treatment group;
iteratively creating each of i) an updated matching control group based on the updated treatment group and ii) an additional updated treatment group based on the updated matching control group until a stop condition occurs, wherein each additional updated treatment group includes an additional geographic region than a preceding treatment group;
receiving input specifying a treatment group size for a given experiment; and
in response to receiving the input specifying the treatment group size for the given experiment, conducting the experiment using i) the updated treatment group that includes a number of geographic regions that matches the treatment group size and ii) the updated matching control group created for that updated treatment group.

16. The computer-readable medium of claim 15, wherein creating a matching control group for the initial treatment group comprises:
determining a first level of the model quality metric based on results provided by an experiment model using the initial treatment group and an initial control group for the initial treatment group;
for each additional geographic regions among multiple different candidate control geographic regions:
i) creating a neighboring control group that includes an additional geographic region or excludes one of the geographic regions included in the initial control group for the initial treatment group, and
ii) determining a second level of the model quality metric based on results provided by the experimental model using the initial treatment group and the neighboring control group;
assigning, as the matching control group for the initial treatment group, one of the neighboring control groups that corresponds to a highest second level of the model quality metric.

17. The computer-readable medium of claim 15, the operations further comprising:
obtaining geographic requirement data specifying a set of geographic regions that are required to be included in the initial treatment group; and
obtaining control data specifying a set of geographic regions that are allowed to be included in a control group of the experiment, wherein:
creating the initial treatment group that includes the one or more geographic regions comprises creating the initial treatment group to include the set of geographic regions that are required to be included in the initial treatment group; and
creating the matching control group for the initial treatment group that includes the one or more geographic regions that are not included in the initial treatment group comprises including, in the matching control group, at least one geographic region from the set of geographic regions that are allowed to be included in the control group of the experiment.

18. The computer-readable medium of claim 15, wherein creating the updated treatment group comprises:
for each additional geographic region among one or more additional geographic regions that are eligible for inclusion in the updated treatment group:
creating a candidate treatment group that includes the additional geographic region and geographic regions that are currently included in an existing treatment group for the experiment;
determining whether the candidate treatment group provides a higher level of the model quality metric than the existing treatment group; and
determining whether to add the additional geographic region to the existing treatment group based on whether the candidate treatment group provides a higher level of the model quality metric than the existing treatment group, including adding the additional geographic region to the existing treatment group to create the updated treatment group when the candidate treatment group provides a higher level of the model quality metric than the existing treatment group, and not adding the additional geographic region to the existing treatment group when the candidate treatment group fails to provide a higher level of the model quality metric than the existing treatment group.

19. The computer-readable medium of claim 15, wherein iteratively creating each of the updated matching control group based on the updated treatment group and the additional updated treatment group based on the updated matching control group until the stop condition occurs comprises iteratively creating each of the updated matching control group and the updated treatment group until a maximum specified number of geographic regions are included in the updated treatment group.

20. The computer-readable medium of claim 15, wherein iteratively creating each of the updated matching control group based on the updated treatment group and the additional updated treatment group based on the updated matching control group until the stop condition occurs comprises iteratively creating each of the updated matching control group and the updated treatment group until an addition of another geographic region to an existing treatment group fails to improve the level of the model quality metric relative to the level of the model quality metric provided by the existing treatment group.
